(19) United States
(12) Patent Application Publication
(10) Pub. No.: US 2026/0008294 A1
(43) Pub. Date: Jan. 8, 2026

(54) PENCIL SHARPENER

(71) Applicant: SDI CORPORATION, CHANG HUA (TW)

(72) Inventor: Che-Chang CHENG, CHANG HUA (TW)

(21) Appl. No.: 19/021,667

(22) Filed: Jan. 15, 2025

(30) Foreign Application Priority Data
Jul. 2, 2024 (TW) 113207062

(51) Int. Cl. B43L 23/08

(52) U.S. Cl. CPC B43L 23/08

(57) ABSTRACT

A pencil sharpener has a base, a blade assembly, and a cap. The blade assembly is mounted to the base and has a first pencil entry. The cap is pivotally connected to a side of the base, configured to pivot between a first position and a second position, and has a second pencil entry whose inner diameter is smaller than an inner diameter of the first pencil entry. When the cap is at the first position, the second pencil entry is located above the first pencil entry along an axis, such that a pencil is insertable into the blade assembly through the second pencil entry and the first pencil entry in order. When the cap is at the second position, the cap is withdrawn from a space above the blade assembly, such that another pencil is insertable into the blade assembly through the first pencil entry along the axis.

### 1. FIELD OF THE INVENTION

The present invention relates to a pencil sharpener, and more particularly to a pencil sharpener capable of sharpening pencils with different outer diameters.

### 2. DESCRIPTION OF RELATED ART

Pencils are provided in different outer diameters. When a conventional pencil sharpener is used for sharpening a thinner pencil, the thinner pencil would oscillate in the conventional pencil sharpener, which is prone to break the pencil lead of the thinner pencil. Otherwise, a user needs to maintain the position of the thinner pencil during sharpening as much as possible, causing difficulty in operation.

Chinese utility model CN 201371686 U discloses a conventional pencil sharpener having a blade assembly and multiple adjusting sheaths. By inserting one or more said adjusting sheaths into a pencil entry of the blade assembly, an inner diameter of the conventional pencil sharpener can be adjusted to match outer diameters of to-be-sharpened pencils.

However, since the adjusting sheaths and the blade assembly are all independent components and the adjusting sheaths are small, the user must carefully store the components when not in use to prevent missing some. Besides, the adjusting sheaths may be designed to tight fit the pencil entry of the blade assembly, but this will also cause installation and detachment difficulties. Therefore, the conventional pencil sharpener disclosed in the Chinese utility model CN 201371686 U is inconvenient in use.

US patent publication US 2014/0090258 A1 discloses another conventional pencil sharpener which has multiple blade assemblies combined together. Each one of the multiple blade assemblies corresponds to pencils with different outer diameters. In this way, carrying this conventional pencil sharpener resembles carrying multiple average conventional pencil sharpeners. The conventional pencil sharpener disclosed in US 2014/0090258 A1 has the shortcomings of high cost and large volume, which leads to difficulties in storage and carrying.

Briefly, the conventional pencil sharpeners have limitations and shortcomings for sharpening pencils with different outer diameters which need to be improved.

### SUMMARY OF THE INVENTION

The main objective of the present invention is to provide a pencil sharpener that is capable of sharpening pencils with different outer diameters and is convenient to store and carry, so as to mitigate the aforementioned shortcomings of the conventional pencil sharpeners.

The pencil sharpener in accordance with the present invention comprises a base, a blade assembly, and a cap. The blade assembly is mounted to the base and has a first pencil entry. The cap is pivotally connected to a side of the base, configured to pivot between a first position and a second position, and has a second pencil entry whose inner diameter is smaller than an inner diameter of the first pencil entry. When the cap is at the first position, the second pencil entry is located above the first pencil entry along an axis, such that a pencil is insertable into the blade assembly through the second pencil entry and the first pencil entry in order. When the cap is at the second position, the cap is withdrawn from a space above the blade assembly, such that another pencil is insertable into the blade assembly through the first pencil entry along the axis.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pencil sharpener in accordance with the present invention, wherein a cap is at a first position;

FIG. 2 is an exploded view of the pencil sharpener in FIG. 1;

FIG. 3 is another perspective view of the pencil sharpener in FIG. 1, wherein the cap is at a second position;

FIG. 4 is a cross-sectional side view of the pencil sharpener in FIG. 1;

FIG. 5 is a cross-sectional side view of the pencil sharpener in FIG. 3;

FIG. 6 is an operational view of the pencil sharpener in FIG. 4;

FIG. 7 is an operational view of the pencil sharpener in FIG. 5;

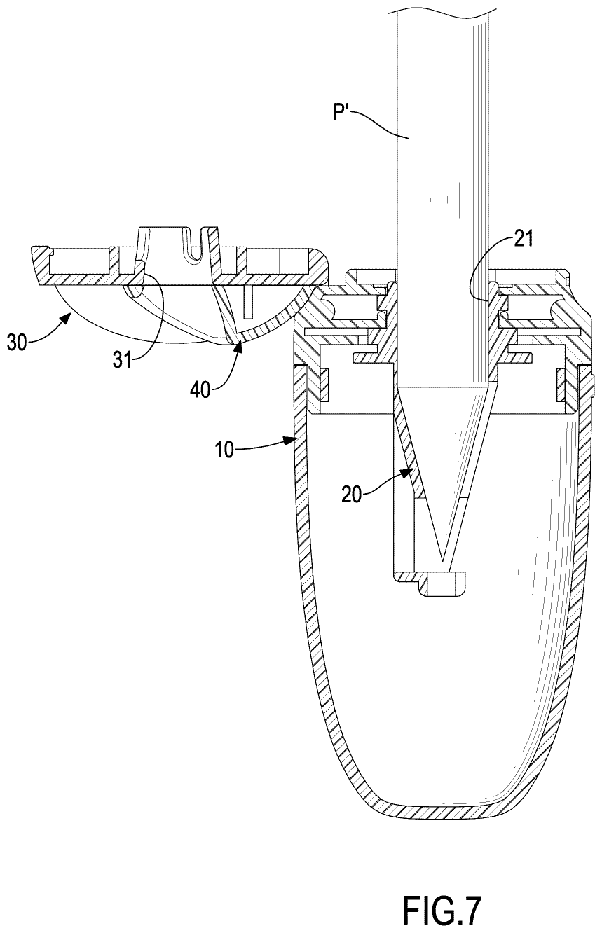

FIG. 8 illustrates the cap and a base abutted on each other of the pencil sharpener in FIG. 1;

FIG. 9 is another operational view of the pencil sharpener in FIG. 4;

FIG. 10 is a cross-sectional top side view across line 10-10 depicted in FIG. 4;

FIG. 11 is a top side view in partial section across line 11-11 depicted in FIGS. 4; and

FIG. 12 illustrates a dust shield of the pencil sharpener in FIG. 11 being at a closed position.

### DETAILED DESCRIPTION OF THE PREFERRED EMBODIMENT

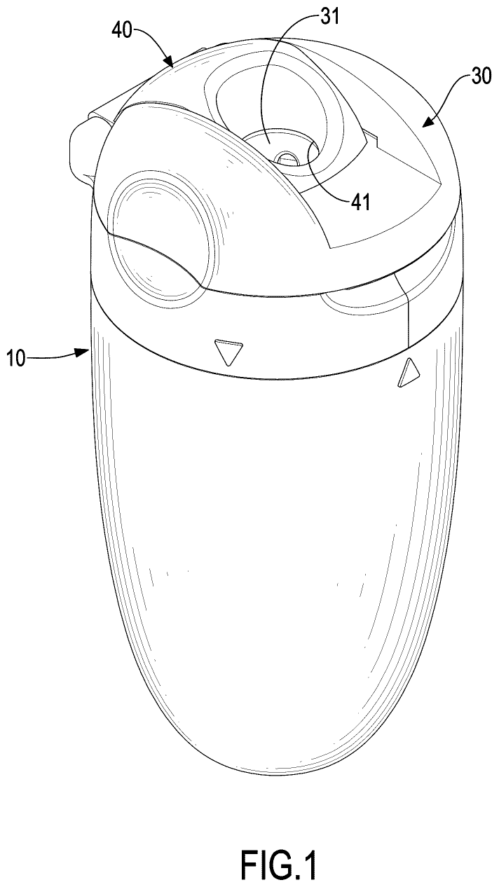

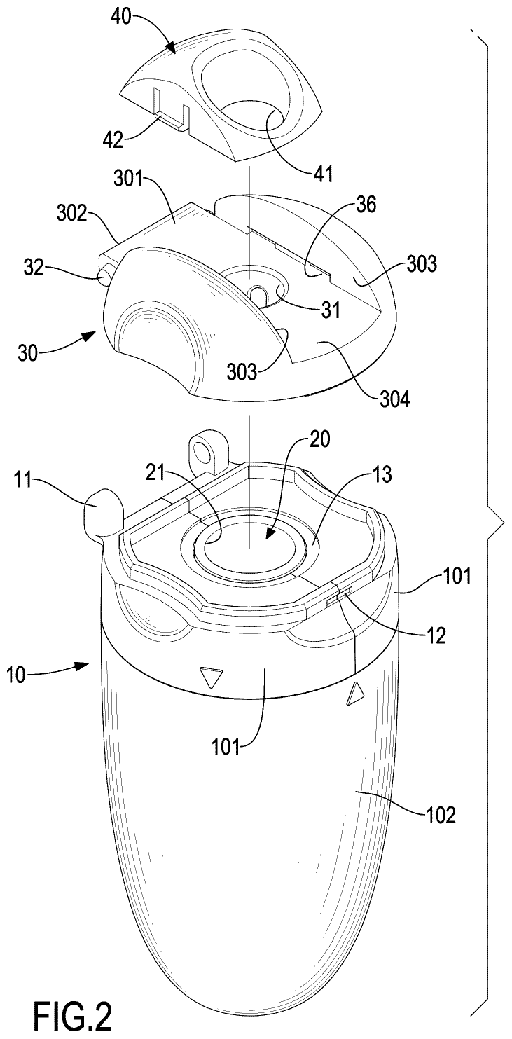

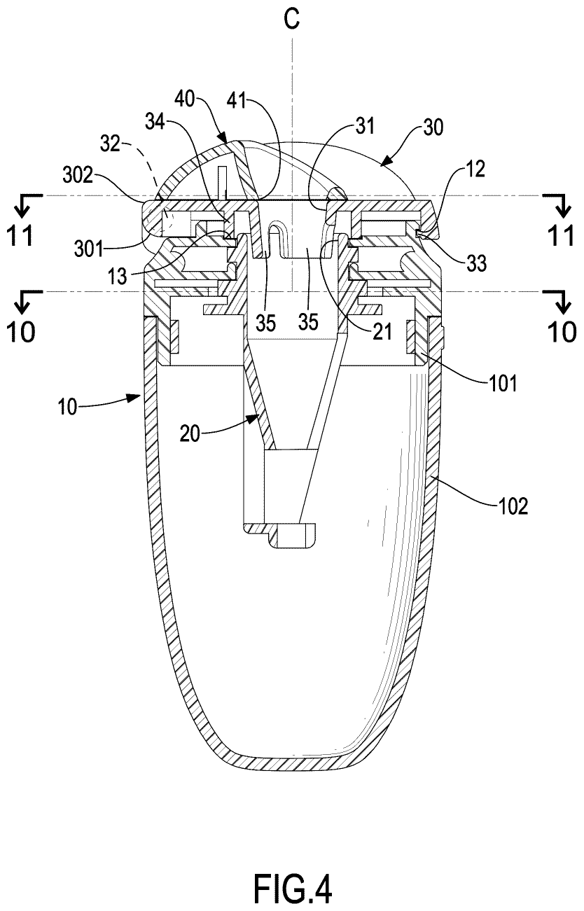

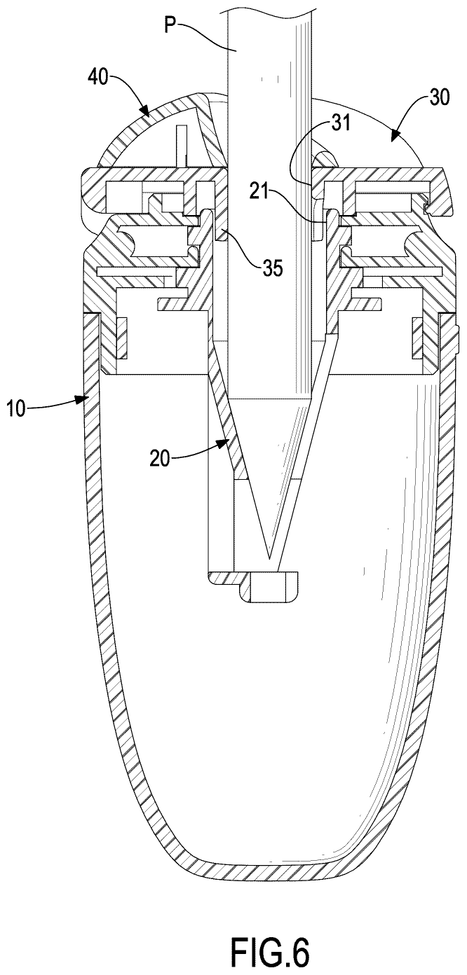

With reference to FIGS. 1 to 4, a preferred embodiment of a pencil sharpener in accordance with the present invention comprises a base 10, a blade assembly 20, and a cap 30. With reference to FIGS. 2 to 4, the blade assembly 20 is mounted on the base 10 and has a first pencil entry 21. The cap 30 is pivotally mounted on a side of the base 10, capable of pivoting to a first position above the blade assembly 20 as shown in FIGS. 1 and 4. The cap 30 has a second pencil entry 31 whose inner diameter is smaller than an inner diameter of the first pencil entry 21. When the cap 30 is at the first position, the second pencil entry 31 is located above the first pencil entry 21 along an axis C, such that, with reference to FIG. 6, a pencil P is insertable into the blade assembly 20 through the second pencil entry 31 and the first pencil entry 21 in order.

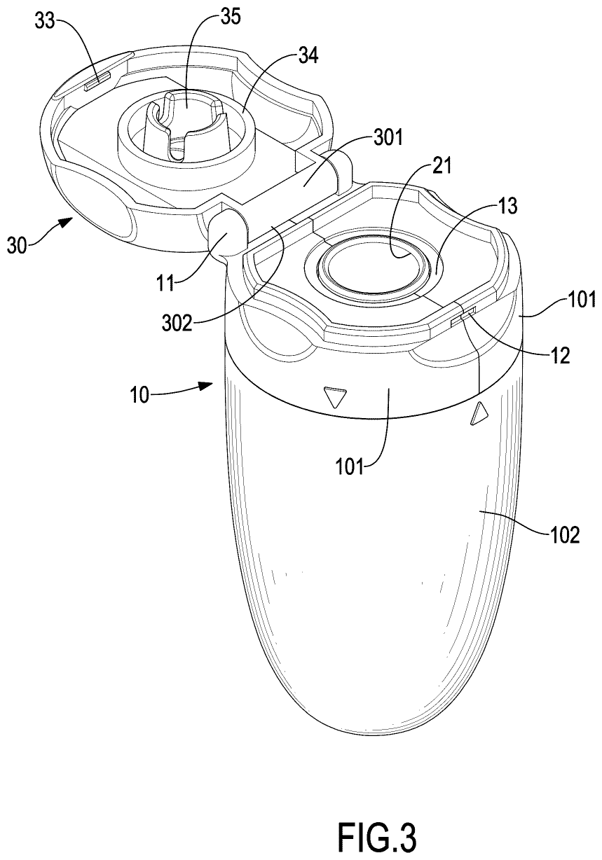

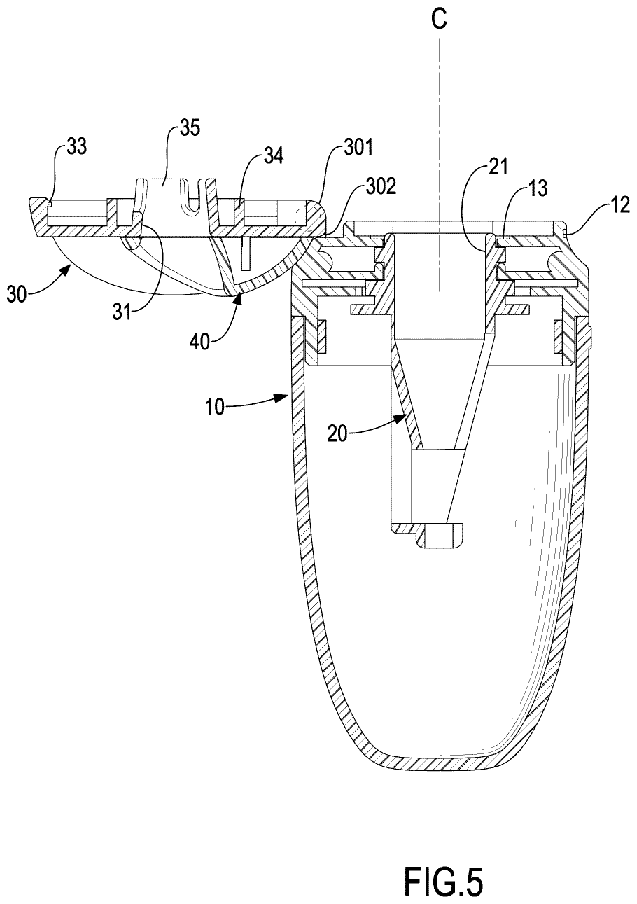

With reference to FIGS. 3 and 5, the cap 30 is also capable of pivoting to the second position, withdrawn from a space above the blade assembly 20, such that the first pencil entry 21 is exposed to a top of the base 10 and a thicker pencil P′ is thereby insertable into the blade assembly 20 through the first pencil entry along the axis C for sharpening.

With the above-mentioned technical features, when intending to sharpen the thicker pencil P′, a user may open the cap 30 to the second position and insert the pencil P′ into the blade assembly 20 for sharpening. (The detailed structural features of the blade assembly 20 for sharpening pencils are similar to the conventional pencil sharpeners.) On the other hand, when intending to sharpen the thinner pencil P, the user may close the cap 30 to the first position, so the pencil P can pass through the second pencil entry 31 of the cap 30 and the first pencil entry 21 of the blade assembly 20 and enter the blade assembly for sharpening. Since the inner diameter of the second pencil entry 31 is smaller than the inner diameter of the first pencil entry 21, the second pencil entry 31 can keep the thinner pencil P on the axis C so as to prevent oscillations of the pencil P and problems of breaking the pencil lead.

Thereby, without substantially increasing a volume of the pencil sharpener, the pencil sharpener in accordance with the present invention utilizes the single blade assembly 20 to realize quality sharpening effect on pencils P, P′ with different outer diameters. The pencil sharpener of the present invention is not only cost-effective and easy for storage, but is also free from component missing problems. Thus, the present invention overcomes the shortcomings of the conventional pencil sharpeners and provides the pencil sharpener capable of sharpening pencils with different outer diameters.

Furthermore, with reference to FIGS. 2 to 5, the top of the base 10 has a first side and a second side, and the first pencil entry 21 is formed between the first side and the second side. The first side is the side of the base 10 to which the cap 30 is pivotally connected, and the second side is engageable with the cap to position the cap 30 at the first position. Specifically, In the preferred embodiment, with reference to FIGS. 2 to 5, the first side of the base 10 has a pair of lugs 11 and the second side of the base 10 has an engaging groove 12. Correspondingly, the cap 30 disposes a pair of pins 32 and an engaging rib 33 on two opposite sides. The pair of pins 32 are inserted into the pair of the lugs to make the cap 30 pivotally connected on the first side of the base 10. When the cap 30 is at the first position, the engaging rib 33 extends into and is engaged with the engaging groove 12 to position the cap 30.

In other embodiments, positions of said lug 11 and said pin 32 can be exchanged, i.e. said lug 11 is formed on the cap 30 and said pin 32 is formed on the base 10. Also, positions of the engaging groove 12 and the engaging rib 33 can be exchanged. Besides, in other embodiments, other pivot mechanisms May be applied, or the engaging means may be substituted by magnetic means or other known positioning means to position the cap 30 at the first position and to make the second pencil entry 31 of the cap 30 coaxial with the first pencil entry of the blade assembly 20.

Preferably, with reference to FIGS. 2 and 3, the cap 30 has a pivot portion pivotally connected with the base 10 and having a positioning edge 302. A position of the positioning edge 302 relative to the base 10 varies as the pivot portion 301 rotates. When the cap 30 is at the first position, with reference to FIG. 4, the positioning edge 302 is located away from the base 10. A surface of the positioning edge 302 is in fact the farthest part of a surface of the pivot portion from a pivot axis, and a radius of curvature of the positioning edge 302 is smaller than other portions of the pivot portion 301, making the surface of the pivot portion 301 a cam surface.

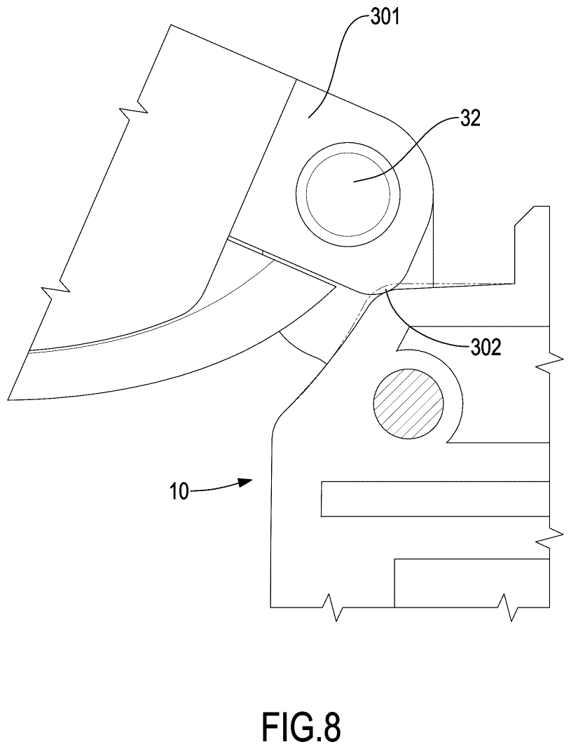

With reference to FIG. 8, when the cap 30 pivots from the first position (FIG. 4) to the second position (FIG. 5), the positioning edge 302 is abutted on the base 10 to position the cap 30 at the second position. After the positioning edge passes a point of abutting, the other portions of the pivot portion 301 are not abutted on the base 10. As exemplified in FIG. 8, a thin chain double dashed line illustrates elastic deformation of the base 10 after being abutted. Practical situations may be: the pivot portion 301 is elastically deformed, both the base 10 and the pivot portion 301 are elastically deformed, or the base 10 and the pivot portion 301 simply rub on each other, not limited to the drawings of the present invention.

Specifically, after the positioning edge 302 is abutted on the base 10, an external force may cause elastic deformations or rubs and drive the positioning edge 302 to pass through, so the cap 30 can smoothly continue pivoting toward the second position. In practice, when the user flips the cap 30 to the second position for sharpening the thicker pencil P′, since the positioning edge 302 tends to be abutted on the base 10, the cap 30 is prevented from easily pivoting toward the base 10, and the user is thereby prevented from being disturbed by oscillations of the cap 30. On the other hand, when the user needs to close the cap 30 on the base 10, the user may exert a slightly stronger force to help the positioning edge 302 with passing the point of abutting to make the cap 30 smoothly pivot to the first position.

In the preferred embodiment, the pair of pins 32 protrude from two ends of the pivot portion 301. In other embodiments, the two ends of the pivot portion may be pivot holes for pivot pins to enter. Moreover, even if the positioning edge 302 of the cap 30 is omitted, the user can still flip the cap 30 away from the blade assembly 20 so as to sharpen the thicker pencil P′ and satisfy the main objective of the present invention.

With reference to FIGS. 3 to 5, the pencil sharpener comprises an engaging structure having an annular protrusion 34 and an engaging recess 13. The annular protrusion 34 and the engaging recess 13 are respectively formed on the cap 30 and the base 10, such that when the cap 30 is at the first position, the annular protrusion 34 extends into the engaging recess 13 and is abutted on an inner sidewall of the engaging recess 13. This prevents relative shakes between the cap 30 and the base 10 due to wear of long-term use or tolerances, and further improves stability of positioning between the cap 30 and the base 10. Thereby, the pencil sharpener of the present invention provides quality operating stability when the user sharpens the thinner pencil P.

Generally, the annular protrusion 34 and the engaging recess 13 are respectively formed on the base 10 and the cap 30, i.e. the engaging recess 13 is formed on one of the base 10 and the cap 30, and the annular protrusion 34 is formed on the other one of the base 10 and the cap 30 at a location corresponding to the engaging recess 13.

In the preferred embodiment, with reference to FIGS. 3 and 5, the engaging recess 13 is disposed on the top of the base 10 adjacent to the first pencil entry 21 of the blade assembly 20, and the annular protrusion 34 protrudes from a bottom of the cap 30. In this way, when the cap 30 is at the second position and the user wants to insert the thicker pencil P′ into the blade assembly 20, the pencil P′ can be successfully inserted rather than be obstructed by the annular protrusion 34.

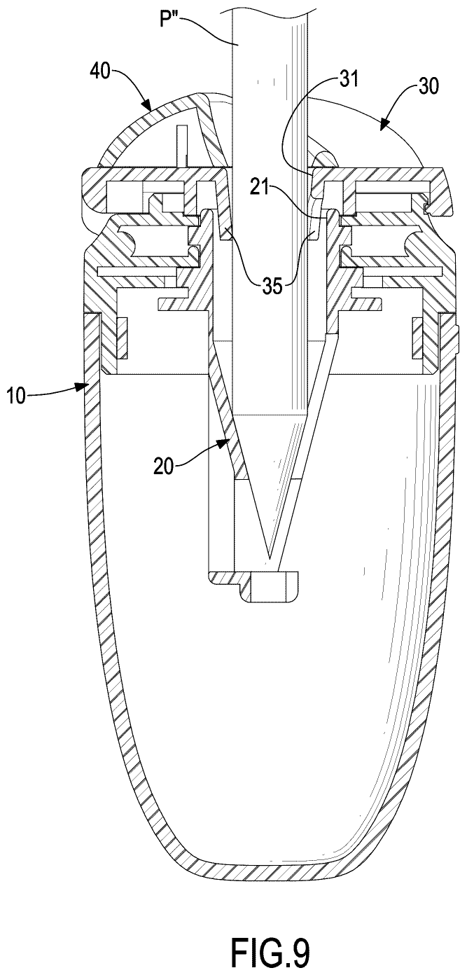

Furthermore, with reference to FIGS. 3 to 5 and 9, the cap 30 further comprises multiple elastic holding units 35. Each one of the elastic holding units protrudes toward the blade assembly 20 and forms a respective holding end. The multiple elastic holding units 35 are arranged around the axis C, such that inner surfaces of the holding ends of the elastic holding units 35 form a holding circle whose inner diameter is smaller than the inner diameter of the second pencil entry. By means of the elastic holding units 35, when the cap 30 is at the first position, the pencil sharpener is capable of sharpening an even thinner pencil P″ as shown in FIG. 9.

Detailedly, with reference to FIG. 6, when the user closes the cap 30, the thinner pencil P is inserted into the blade assembly 20 via the second pencil entry and the first pencil entry 21, and then the multiple elastic holding units 35 are elastically pushed outwardly. That is, the holding ends of the elastic holding units expand radially to an extent that the pencil P can pass therethrough. At the same time, the elastic holding units 35 contract inwardly and steadily hold the pencil P.

The user may otherwise insert the even thinner pencil, whose outer diameter falls between the inner diameters of the holding circle and the second pencil entry 31, or, as shown in FIG. 9, the outer diameter of the even thinner pencil P″ is substantially equal to the inner diameter of the second pencil entry 31. Held by the slightly-deformed elastic holding units 35 or limited by the holding circle, the pencil P″ can be prevented from oscillating during sharpening after passing through the elastic holding units 35. By means of the aforementioned technical features, the pencil sharpener of the present invention is applicable to the pencils P, P′, P″ of more than three different outer diameters, and an overall volume of the pencil sharpener does not noticeably increase, thereby effectively improving utility of the pencil sharpener.

Specifically, in the preferred embodiment, with reference to FIG. 3, each said elastic holding unit 35 is a curved elastic piece fitting the pencils P, P″ in shape, i.e. an inner surface of the elastic holding unit 35 partially matches configurations of the pencils P, P″, thereby further steadying postures of the pencils P, P″ and improving operating stability of pencil sharpening.

Moreover, in the preferred embodiment, the elastic holding units 35 form a tapering conical space, which provides a guiding effect in favor of pencil insertion. In addition, in the preferred embodiment, the elastic holding units 35 extend into the first pencil entry 21 to hold the pencil P, P″ at a place even nearer to where the pencil P, P″ is sharpened by the blade assembly 20, improving operating stability.

Furthermore, with reference to FIGS. 2 to 4 and 10, the base 10 and the blade assembly 20 are connected via a ratchet mechanism such that the blade assembly 20 is unidirectionally rotatable to the base 10.

Specifically, the base 10 comprises two shells 101 and a shaving receptacle 102. The two shells 101 are configured to mount to each other and jointly form the top of the base 10. Each one of the lugs 11 is formed on a respective one of the two shells 101, the engaging groove 12 is jointly formed by the two shells 101, and the blade assembly 20 is jointly clamped by the two shells 101. The shaving receptacle 102 is mounted on bottoms of the two shells for receiving the blade assembly 20 and collecting shavings of pencils from the same.

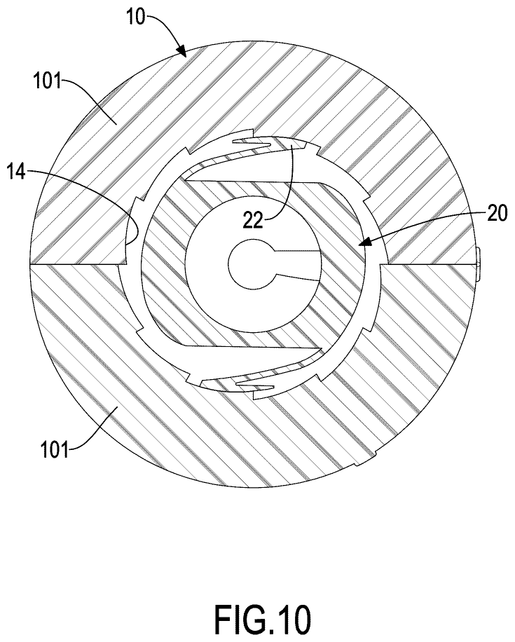

With reference to FIG. 10, the ratchet mechanism comprises multiple pawls 22 and multiple teeth 14. The multiple pawls 22 are formed on an outer periphery of the blade assembly 20 at spaced intervals. The multiple teeth 14 are formed on inner peripheries of the two shells 101 of the base 10. Therefore, when the blade assembly 20 and the base 10 are assembled, the multiple pawls 22 and the multiple teeth 14 can engage with each other and collaborate to make the blade assembly 20 unidirectionally rotatable to the base 10.

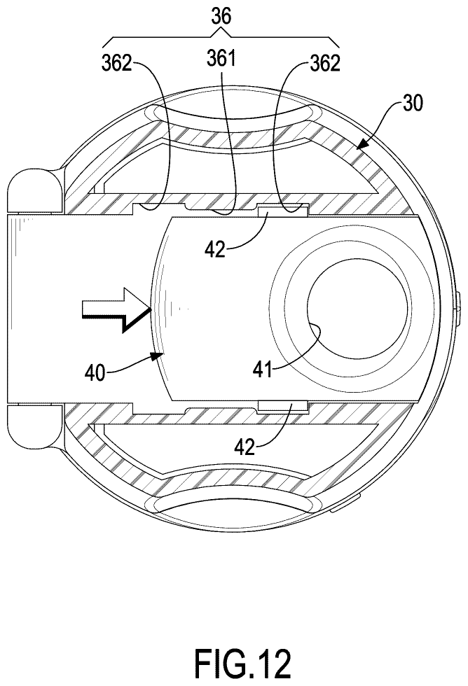

With reference to FIGS. 2, 4, 11, and 12, the pencil sharpener comprises a dust shield 40 movably mounted on the cap 30 between an open position and a closed position and configured to cover the second pencil entry 31, as shown in FIG. 12. Thereby, after use, the dust shield 40 may be pushed to the closed position to prevent the shavings of pencils in the shaving receptacle 102 of the base 10 from falling off through the first pencil entry 21 and the second pencil entry 31 and dirtying the environment in which the user stores the pencil sharpener.

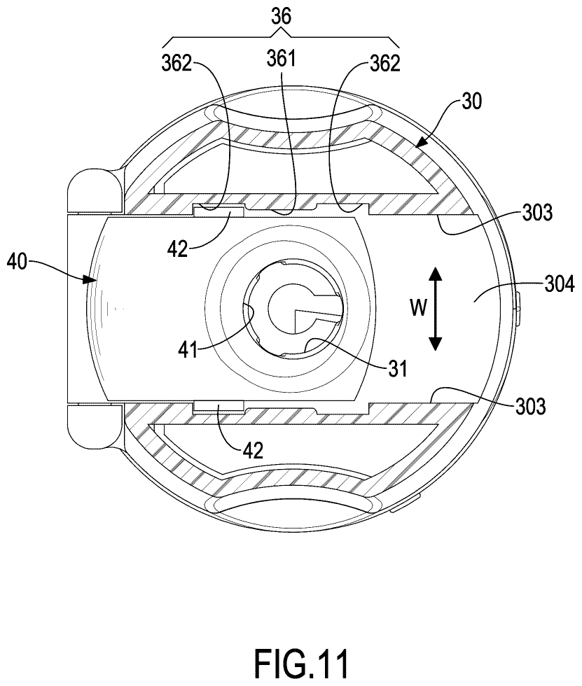

Specifically, the dust shield 40 is slidably mounted on the cap 30 between the open position (FIG. 11) and the closed position (FIG. 12). The dust shield 40 has a through hole 41. When the dust shield 40 is at the closed position, with reference to FIG. 12, the through hole 41 and the second pencil entry 31 are obstructed from each other, so the shavings of pencils are secured in the base 10. When the dust shield 40 is at the open position, with reference to FIGS. 1, 4, and 11, the second pencil entry 31 is fully exposed via the through hole 41 in favor that the user can insert the thinner pencil P, P″ for sharpening.

In other potential embodiments, the dust shield 40 can be a smaller cover board configured to move on the cap 30 and switch between shielding and exposing the second pencil entry 31.

Preferably, with reference to FIGS. 2, 11, and 12, when the dust shield 40 is located between the open position and the closed position, the dust shield 40 and the cap 30 are abutted and elastically deformed, such that the dust shield 40 intends to move toward the open position and the closed position.

Specifically, in the preferred embodiment, the cap 30 has two opposite walls 303 and a platform 304 between the two walls 303. The second pencil entry is disposed on the platform 304, and the dust shield 40 is slidably mounted on the platform 304. Each one of the two walls 303 has a slide groove 36 disposed thereon along a widthwise direction W. The widthwise direction W is perpendicular to a direction along which the dust shield 40 slides. With reference to FIGS. 11 and 12, said slide groove 36 has a middle part 361 and two side parts 362. The middle part 361 has a smaller depth along the widthwise direction W and said side part 362 has a greater depth along the same.

The dust shield 40 has two opposite sidewalls each having an elastic engaging block 42, such that when the dust shield 40 slides on the cap 30, said elastic engaging block 42 is either abutted and elastically deformed by the middle part 361 of a respective one of the two slide grooves 36, or extends into one of the two side parts 362 of the slide groove 36 for positioning. In other words, the two side parts 362 of each one of the two slide grooves 36 correspond to the open position and the closed position of the dust shield 40, respectively.

When the user moves the dust shield 40 to make the dust shield 40 located between the open position and the closed position, since the middle parts are shallower, the two elastic engaging blocks 42 are pressed by the middle parts 361 and elastically deformed. When the dust shield 40 is moved to either the open position or the closed position, the two engaging blocks 42 bounce back and extend into the deeper side parts 362 of the two slide grooves 36 to complete positioning. Thereby, the dust shield 40 tends to be positioned at either the open position or the closed position.

Alternatively, another embodiment may comprise: the cap 30 having only one said slide groove 36, the dust shield 40 having only one said elastic engaging block 42, and the wall 303 of the cap 30 and the sidewall of the dust shield 40 on the opposite side barely abutted on each other. By the elastic engaging block 42 being pressed by the middle part 361 of the slide groove 36, the dust shield 40 still tends to be positioned at either the open position or the closed position. Further, another embodiment may exchange the technical features of the cap 30 and the dust shield 40. That is, said elastic engaging block is disposed on the cap 30 and said slide groove 36 is disposed on the dust shield 40. The above-mentioned technical effect can be achieved in this situation as well.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pencil sharpener comprising:
a base;
a blade assembly mounted to the base and having a first pencil entry; and
a cap pivotally connected to a side of the base, configured to pivot between a first position and a second position, and having a second pencil entry whose inner diameter is smaller than an inner diameter of the first pencil entry; wherein
when the cap is at the first position, the second pencil entry is located above the first pencil entry along an axis, such that a pencil is insertable into the blade assembly through the second pencil entry and the first pencil entry in order;
when the cap is at the second position, the cap is withdrawn from a space above the blade assembly, such that another pencil is insertable into the blade assembly through the first pencil entry along the axis.

2. The pencil sharpener as claimed in claim 1, wherein
a top of the base has
a first side being the side of the base to which the cap is pivotally connected; and
a second side being engageable with the cap to position the cap at the first position; and
the first pencil entry of the blade assembly is disposed between the first side and the second side.

3. The pencil sharpener as claimed in claim 1, wherein
the cap has a pivot portion pivotally connected with the base and having a positioning edge;
when the cap is at the first position, the positioning edge is located away from the base; and
when the cap pivots from the first position to the second position, the positioning edge abutted on the base to position the cap at the second position.

4. The pencil sharpener as claimed in claim 1, wherein the pencil sharpener comprises an engaging structure having
an engaging recess disposed on a bottom of the cap; and
an annular protrusion protruding from a top of the base at a location adjacent to the first pencil entry, such that when the cap is at the first position, the annular protrusion extends into the engaging recess and is abutted on an inner sidewall of the engaging recess.

5. The pencil sharpener as claimed in claim 1, wherein the pencil sharpener comprises an engaging structure having
an engaging recess disposed on a top of the base at a location adjacent to the first pencil entry; and
an annular protrusion protruding from a bottom of the cap such that when the cap is at the first position, the annular protrusion extends into the engaging recess and is abutted on an inner sidewall of the engaging recess.

6. The pencil sharpener as claimed in claim 1, wherein
the cap has multiple elastic holding units each protruding toward the blade assembly and each forming a respective holding end;
the multiple elastic holding units are arranged around the axis, such that inner surfaces of the holding ends of the elastic holding units form a holding circle whose inner diameter is smaller than the inner diameter of the second pencil entry.

7. The pencil sharpener as claimed in claim 1, wherein the base and the blade assembly are connected through a ratchet mechanism such that the blade assembly is unidirectionally rotatable to the base.

8. The pencil sharpener as claimed in claim 1, wherein the pencil sharpener comprises a dust shield movably mounted on the cap between an open position and a closed position and configured to cover the second pencil entry.

9. The pencil sharpener as claimed in claim 2, wherein the pencil sharpener comprises a dust shield movably mounted on the cap between an open position and a closed position and configured to cover the second pencil entry.

10. The pencil sharpener as claimed in claim 3, wherein the pencil sharpener comprises a dust shield movably mounted on the cap between an open position and a closed position and configured to cover the second pencil entry.

11. The pencil sharpener as claimed in claim 4, wherein the pencil sharpener comprises a dust shield movably mounted on the cap between an open position and a closed position and configured to cover the second pencil entry.

12. The pencil sharpener as claimed in claim 5, wherein the pencil sharpener comprises a dust shield movably mounted on the cap between an open position and a closed position and configured to cover the second pencil entry.

13. The pencil sharpener as claimed in claim 6, wherein the pencil sharpener comprises a dust shield movably mounted on the cap between an open position and a closed position and configured to cover the second pencil entry.

14. The pencil sharpener as claimed in claim 7, wherein the pencil sharpener comprises a dust shield movably mounted on the cap between an open position and a closed position and configured to cover the second pencil entry.

15. The pencil sharpener as claimed in claim 8, wherein
the dust shield is slidably mounted on the cap between the open position and the closed position and has a through hole;
when the dust shield is at the closed position, the through hole and the second pencil entry are obstructed from each other; and
when the dust shield is at the open position, the second pencil entry is fully exposed via the through hole.

16. The pencil sharpener as claimed in claim 8, wherein
the cap and the dust shield respectively have at least one slide groove and at least one elastic engaging block;
said elastic engaging block is received in said slide groove;
said slide groove has two side parts having greater depths and a middle part having a smaller depth;
when the dust shield slides on the cap, said elastic engaging block is either abutted and elastically deformed by the middle part of said slide groove, or extends into one of the two side parts of said slide groove for positioning.
